(19) United States
(12) Patent Application Publication
(10) Pub. No.: US 2010/0115140 A1
(43) Pub. Date: May 6, 2010

(54) ENCODED ADDRESSING WITHIN CONTROL CODE FOR BUS COMMUNICATION

(75) Inventor: Neal Anthony Galbo, Boca Raton, FL (US)

Correspondence Address: LEFFERT JAY & POLGLAZE, P.A., P.O. BOX 581009, MINNEAPOLIS, MN, 55458-1009, US

(73) Assignee: Micron Technology, Inc.

(21) Appl. No.: 12/261,835

(22) Filed: Oct. 30, 2008

(51) Int. Cl. G06F 13/20

(52) U.S. Cl. 710/3; 710/5

(57) ABSTRACT

Electronic devices and methods facilitate encoding target device identification in data packets transmitted on a communications bus. For example, unique tokens are generated and encoded with unique identification information to identify target devices coupled to a communications bus. Unique tokens and encoded device identification information may be selected such that the tokens will not appear as part of other data appearing on the communications bus.

### TECHNICAL FIELD

The present disclosure relates generally to electronic devices and in particular the present disclosure relates to methods and apparatus for communication between electronic devices coupled by a communications bus.

### BACKGROUND

Many electronic devices can be coupled to other electronic devices so that the devices may communicate with each other over a communications bus. These electronic devices are sometimes referred to as peripheral devices or bus coupled devices. For example, many types of memory devices can be coupled to a host, such as a microprocessor, in order to create an electronic system. Memory devices are often provided as internal, semiconductor, integrated circuits in computers or other electronic devices. There are many different types of memory including random-access memory (RAM), read only memory (ROM), dynamic random access memory (DRAM), synchronous dynamic random access memory (SDRAM), and flash memory.

Flash memory devices have developed into a popular source of non-volatile memory for a wide range of electronic applications. Non-volatile memory is memory that can retain its stored data for some extended period without the application of power. Common uses for flash memory and other non-volatile memory include personal computers, personal digital assistants (PDAs), digital cameras, digital media players, digital recorders, games, appliances, vehicles, wireless devices, mobile telephones and removable memory modules, and the uses for non-volatile memory continue to expand.

Flash memory devices typically use a one-transistor memory cell that allows for high memory densities, high reliability, and low power consumption. Storing data in a flash memory cell can be accomplished by changing the threshold voltage of the cell, through programming or “writing” of charge storage nodes, such as floating gates or trapping layers, or other physical phenomena. By defining two or more ranges of threshold voltages to correspond to individual data states, one or more bits of information may be stored on each cell. Examples are single level and multilevel memory cells.

Flash memory typically utilizes one of two basic architectures known as NOR flash and NAND flash. The designation is derived from the logic used to read the devices. In NOR flash architecture, a column of memory cells are coupled in parallel with each memory cell coupled to a transfer line, often referred to as a bit line. In NAND flash architecture, a column (e.g., NAND string) of memory cells are coupled in series with only the first memory cell of the column coupled to a bit line.

In many modem flash memory device implementations, the host interface and erase block management routines additionally allow for the flash memory device to appear as a read/write mass storage device (e.g., a magnetic disk) to the host. One such approach is to conform the interface to the flash memory to a standard interface for a conventional magnetic hard disk drive allowing the flash memory device to appear as a block read/write mass storage device or disk. This approach has been codified by the Personal Computer Memory Card International Association (PCMCIA), Compact Flash (CF) and Multimedia Card (MMC) standardization committees, which have each promulgated a standard for supporting flash memory systems, which are sometimes referred to as flash memory “cards,” which can emulate a hard disk drive protocol. Other such protocols exist as are known to those skilled in that art.

The various types of memory discussed above are typically coupled to the host or other devices in the system through various types of communications busses. These communications busses allow for the transfer of information between the devices, such as various commands and data, for example. Typically these communications busses comprise one or more communications channels. Various types of communications busses are known to those skilled in the art. For example, a serial bus typically consists of a single communications channel capable of sending and/or receiving a single data stream of data (e.g., bits). Another typical bus configuration is a parallel bus. A parallel bus consists of two or more communications channels configured to send multiple streams of data down each bus channel of the parallel bus. The data streams of parallel busses are typically synchronized with each other both in timing and in direction. Both serial and parallel bus configurations might be configured as unidirectional (e.g., one-way) and/or bi-direction (e.g., two way) busses.

A typical operation performed by a host (e.g., processor) coupled to one or more devices is to send packets of information to the devices over a communications bus such as instructions and/or data that is typically intended for a particular device in the system. One aspect of technology that continues to increase is the bus speeds (e.g., throughput) of communications busses. For example, bus speeds into the gigahertz range are currently in use and bus speeds continue to increase. Often more than one device (e.g., peripheral device), such as shown in FIG. 1, is coupled to a common bus. Thus, there must be a means for the peripheral devices coupled to the bus to know if the information appearing on the bus is intended for that device or not. Otherwise, multiple devices may malfunction due to accepting data not intended for the device and/or multiple devices may attempt to respond on the bus at the same time, commonly referred to as bus contention. One method to indicate an intended target is to provide a separate hardware signal to each bus device (e.g., chip select, enable signal, etc.) that indicates that the information present on the bus at that particular time is intended for the enabled device. An alternative method is to include information in the data packet that indicates what device the information is intended for. This is sometimes referred to as a header of the data packet. One issue that can arise is that bus devices typically need to receive the entire data packet, then perform an analysis of the data packet to determine if the data packet was intended for the device. This receive/analysis operation consumes both time and power. For example, many devices operate in a low power (e.g., “sleep mode”) until they detect activity on the bus. These devices must wake up and perform a receive/decode operation on the entire data packet. If the peripheral device makes the determination that the data packet was not intended for the device, the device has taken the time and power to analyze the entire packet without needing to before returning to sleep mode. Thus, both time and power resources have been expended (e.g., wasted) when the data present on the bus was not intended for that peripheral device. This expenditure of time and power in these peripheral devices is especially important in devices that have limited power available, such as battery powered devices, for example. As the need to conserve power continues to increase, the time and energy required of peripheral devices to perform a receive/decode operation should be reduced if possible.

Thus, for the reasons stated above, and for other reasons that will become apparent to those skilled in the art upon reading and understanding the present specification, there is a need in the art for alternative methods of identifying intended recipients of information communicated to devices coupled by a communications bus.

### BRIEF DESCRIPTION OF THE DRAWINGS

FIG. 1 is a functional block diagram of an electronic system having a host with a plurality of attached electronic devices configured in a chaining type bus configuration according to an embodiment of the present disclosure.

FIG. 2 is a functional block diagram of an electronic system having a host with a plurality of attached electronic devices configured in a multi-drop bus configuration according to an embodiment of the present disclosure.

FIG. 3 is a block diagram of a information packet according to an embodiment of the present disclosure.

FIG. 4 is a block diagram of a control code according to an embodiment of the present disclosure.

FIG. 5 is a block diagram of an electronic device according to an embodiment of the present disclosure.

### DETAILED DESCRIPTION

In the following detailed description of the present embodiments, reference is made to the accompanying drawings that form a part hereof, and in which is shown by way of illustration specific embodiments in which the disclosure may be practiced. These embodiments are described in sufficient detail to enable those skilled in the art to practice the embodiments of the invention, and it is to be understood that other embodiments may be utilized and that electrical, mechanical or process changes may be made without departing from the present disclosure. The following detailed description is, therefore, not to be taken in a limiting sense.

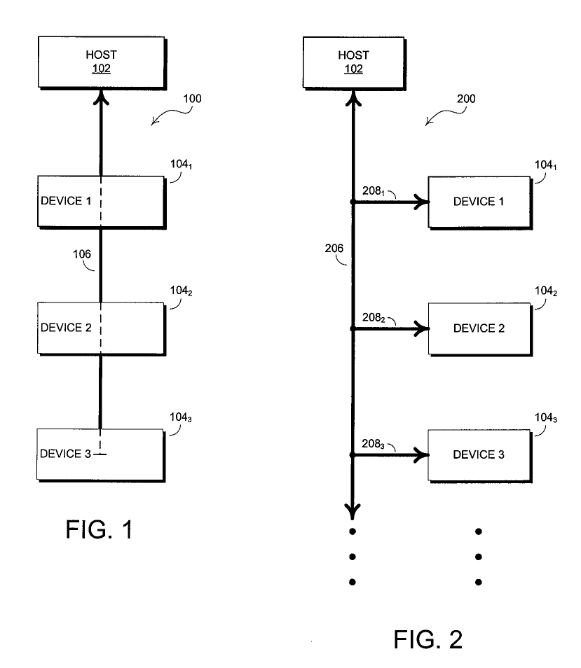

FIG. 1 is a functional block diagram of an electronic system 100 according to one or more embodiments of the present disclosure utilizing a chain type bus architecture. The chain type architecture utilizes a communications bus 106 that passes through each peripheral device 104 coupled to the bus. Packets of data presented on the bus by the host 102 passes through each peripheral 104 on the bus 106 until the packet hits the last peripheral device 1043 located at the end of the chain. Another type of bus architecture is a drop type bus architecture as illustrated by FIG. 2. In the drop type bus architecture shown in FIG. 2, the one or more peripheral devices 104 are coupled to the communications bus 206 by taps (e.g., stubs) 208 located along the bus 206. Although three peripheral devices 104 are shown coupled to the bus 106/206 in FIGS. 1 and 2, respectively, systems 100/200 according to various embodiments of the present disclosure might comprise one or more peripheral devices. In addition, a peripheral device coupled to a communications bus may also comprise wireless communications such as through radio frequency (RF) and/or light (e.g., infrared) communications methods, for example.

The communications bus 106/206 can be one or more of a number of types of communications busses as are known to those skilled in the art. For example, the bus 206 might be of serial and/or parallel communications bus type. Bus 106 might be a Firewire type bus as is known in the art, for example. The host 102 can be a processor (e.g., microprocessor) or some other type of controlling circuitry capable of presenting (e.g., transmitting) and/or receiving data on the communications bus. Thus, the host 102, communications bus 106/206 and the coupled peripheral devices 104 form part of an electronic system 100/200, respectively.

Peripheral devices 104 have been simplified to focus on features of the system that are helpful in understanding the embodiments of the present disclosure. These peripheral devices 104 can include a variety of electronic devices configured to communicate on a communications bus. For example, a peripheral device 104 may be a hardwired or removable memory device. Examples of these memory devices can be RAM, ROM, FLASH memory, USB memory sticks, SD memory cards, MMC memory cards, SATA devices (e.g., magnetic hard drives) and other types of memory devices as are known to those skilled in the art. FLASH memory for example, typically includes an array of FLASH memory cells that can be arranged in banks of logical rows and columns. The memory array can be an array of flash memory cells arranged in a NAND or NOR configuration, for example as is known to those skilled in the art. Although they may contain memory of some type, peripheral devices 104 can also be non-memory specific electronic devices. For example these peripheral devices might be devices such as electronic subsystems to the system 100/200. These peripherals may also be other types of electronic devices such as additional processors (e.g., slave devices), electronic sensors, transmitters, receivers, display devices, or a variety of sensory input and/or output devices as are known to those skilled in the art. Typically these peripheral devices will contain some number of registers capable of registering (e.g., latching) data present on the communications bus that the peripheral is coupled to, for example.

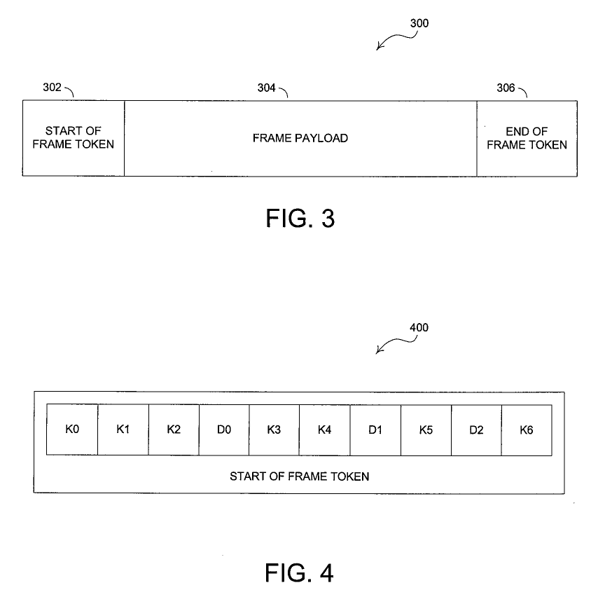

Various bus protocols exist which are structured in a way in which packets of data, often referred to in the art as frames of data, are sent over the bus such as the bus 106/206 shown in FIGS. 1 and 2. FIG. 3 illustrates a graphical representation of a frame of data 300 to be transmitted on a communications bus of the various types discussed above. Some examples of bus protocols utilizing a data frame structure such as illustrated in FIG. 3 are USB, Ethernet, Synchronous Data Link Control (SDLC), High Level Data Link Control (HDLC) and others as are known to those skilled in the art. The various bus protocols have defined control codes (e.g., tokens) that identify and delineate data packets sent on a communications bus. These tokens are unique and are encoded outside of the values of the data set that represents the data (e.g., non-control code data) transmitted with the data packet. These tokens in some cases precede and/or follow the frame payload to be communicated from the host to the peripheral and vice versa. For example, 8b/10b encoding utilizes a unique start of frame control code, often referred to in the art as a start of frame token which is used to indicate the beginning of a new frame of data. The data payload then follows (e.g., is appended to) the start of frame token. Another control code follows (e.g., is appended to) the frame payload and is typically referred to as an end of frame control code (e.g., end of frame token) which is used to indicate the end of the data payload to be communicated. As illustrated in FIG. 3, a frame 300 might consist of a start of frame token 302, followed by the frame payload 304 and ending with an end of frame token 306, for example. These tokens have a unique bit pattern which peripheral devices recognize as an indication of a start or end of the frame 300. These unique tokens will not be found in the data stream so that the devices coupled to the bus can definitively identify these tokens as a control code. Under these protocols, once a start of frame token 302 has been received by a device, the device will buffer (e.g., latch) the frame payload 304 following the receipt of the start of frame token 302. The data in the frame payload 304 can often comprise a large amount of data (e.g., bits) to be communicated. For example, the frame payload 304 might be 1 k to 100 k bits in length. As discussed above, these protocols need to utilize a method in order to indicate to which of a number of possible coupled peripheral devices a particular data frame is intended. Thus, these protocols add addressing information to the frame payload along with the frame payload data, typically in a fixed location in the frame payload. Thus, a peripheral device must first register and identify the start of frame token 302. The peripheral device then proceeds to buffer (e.g., latch) the frame payload 304, including any fixed addressing information that might be included in the frame payload, along with the data portion of the frame payload. As mentioned above, the frame payload might comprise a large amount of data (e.g., bits) before the receipt of an end of frame token 306 is received. The end of frame token 306 is a unique token that is utilized by the bus protocol to indicate to the peripheral device that the complete frame of data has been received.

Once the entire frame payload has been buffered by the peripheral device, the peripheral device circuitry then analyzes and determines if the received frame of data was indeed intended (e.g., addressed) for that particular peripheral device. This analysis is typically performed by various means such as by firmware or some other logic circuitry in the peripheral device. If the device determines the buffered data frame was intended for that peripheral device, then the device proceeds to act upon the received information as appropriate. However, if the logic of the peripheral device determines that the buffered data frame was not intended for that peripheral device, then the peripheral device will not act upon the received data frame and will flush the received data. The peripheral device then waits for the next receipt of a start of frame token to be detected on the bus to repeat the process as described above.

In the event described above wherein the data frame was not intended for the peripheral device, the process of buffering the data, analyzing the data and flushing the buffered data has been performed needlessly. These actions consume both time and power that was not ultimately needed to be expended. This can affect both throughput and power consumption of the system in which the peripheral is a component. Various embodiments of methods and devices according to the present disclosure serve to mitigate these effects.

Typically, control codes (e.g., tokens), such as those indicating a start of frame, are of a fixed length (e.g., number of bits.) Out of all the possible bit patterns, typically only a small number of these are used as control codes. For example, the 8b/10b encoding bus communications protocol as is known to those skilled in the art is an 8 bit to 10 bit encoding scheme yielding a 10 bit pattern from an 8 bit pattern. Of the possible 1024 values that that can be represented by 10 bits, the 8b/10b encoding scheme consumes 512 of these values for data. Thus, this leaves 512 possible 10 bit values to be utilized for other purposes. A small number of these 512 possible 10 bit codes are utilized as control codes as these control codes will not appear in the data of the frame payload. One such code is utilized in the 8b/10b encoding scheme as a start of frame token as discussed above. Instead of utilizing a single control code as a start of frame token as is currently done, various embodiments of the present disclosure utilize a particular number of these unused control codes as start of frame tokens. Each of the particular number of unique start of frame tokens not only indicates a start of frame but are also selected so as to comprise an identifying bit pattern that is uniquely associated with a peripheral device coupled to a communications bus, such as peripheral 1042 coupled to the communications bus 106 as illustrated in FIG. 1, for example.

FIG. 4 illustrates an example of a start of frame token 400, such as start of frame token 302, incorporating unique peripheral device identification adapted from a particular set of control codes according to one or more embodiments of the present disclosure. The token 400 illustrated in FIG. 4 provides for unique addressing of eight peripheral devices coupled to a communications bus. However, the various embodiments are not limited to eight peripheral devices. The number of possible unique peripheral identification values according to various embodiments of the present disclosure is a function of the total number of bit positions and available control codes (e.g., bit patterns not used for data) of the encoding scheme. Bit locations K0-K6 of FIG. 4 could be representative of the start of frame control code (e.g., start of frame base code) for a particular encoding scheme according to one or more embodiments of the present disclosure. The remaining bit locations of the token 400, D0-D2 represent the three bit locations used to uniquely identify each of the eight possible peripheral devices coupled to the communications bus.

Thus, a bus coupled device configured to utilize an encoding scheme embodiment such as illustrated by FIG. 4 might be adapted to recognize that a particular bit pattern in locations K0-K6 of a received token is representative of a start of frame token according to the encoding scheme utilized in the system. For example, a bit pattern of all 1s in bit locations K0-K6 of the token 400 might be assigned to indicate a start of frame token. However, the various embodiments of the present disclosure are not limited to such a bit pattern. Any combination of 1s and 0s present in the bit locations K0-K6 might be utilized as long as the pattern provides for the unique identification of a control code. Control codes in addition to start of frame codes as discussed are possible according to one or more embodiments of the present disclosure. For example, according to at least one embodiment, a bit pattern of all 1s in bit positions K0-K6 of token 400 might be representative of a start of frame token and all 0s in the K0-K6 bit positions might be representative of an end of frame token. Other possible bit combinations, bit locations and control codes are possible according to various embodiments of the present disclosure. In general, the encoding scheme provides for a command having a first portion that remains the same each time the command is placed on a communications bus, and a second portion that is unique to the peripheral device that is intended to operate upon that command. These portions may be contiguous or interleaved within the command structure.

In addition to the bit positions K0-K6 of token 400 which are utilized to indicate a particular type of control code (e.g., start of frame token), bit positions D0-D2 are utilized to identify a particular peripheral device coupled to the communications bus of an electronic system such as shown is FIGS. 1 and 2 and discussed above. According to at least one embodiment as represented by the token 400 illustrated in FIG. 4, there are three possible bit positions (D0, D1, D2) available for peripheral device identification. Thus, as 2̂3=8, there are eight possible peripherals that can be identified. Although, each peripheral device coupled to the communications bus may recognize the start of frame bit pattern K0-K6 of token 400, these peripheral devices configured in accordance with various embodiments herein are configured to ignore the frame payload 304 following the recognized start of frame token unless the unique peripheral device identification bits D0-D2, match the bit pattern assigned to that particular peripheral device. If the peripheral device is identified by the bit locations D0-D2 then the peripheral device will begin to buffer the frame payload 304 which follows the start of frame token 302 until an appropriate end of frame token 306 has been detected. The peripheral device logic (e.g., functionality) can then utilize the frame payload data as appropriate without further analysis because the buffered data would not have been captured if the frame payload was not intended for that peripheral device. Thus, the peripheral device does not waste resources in buffering and analyzing data received on the communications bus if the data frame was not intended for that peripheral device. This results in a savings of both time and power utilized by the peripheral device.

Many peripheral devices operate in a sleep mode when not actually performing operations and are configured to wake up when a start of frame token has been detected. Embodiments of the present disclosure allow for a peripheral device to return to sleep mode faster upon the receipt of the start of frame token if the data frame is not intended for that peripheral device. Returning to sleep mode faster can reduce power consumption and is especially important in low power systems such as battery operated devices.

According to various embodiments of the present disclosure, the peripheral devices need to be configured to respond to their respective assigned unique peripheral device identification value. Assignment of the unique peripheral device identifiers according to one or more embodiments of the present disclosure is shown by way of reference to Table 1. It should be noted that the bit values and bit positions illustrated in Table 1 are provided as an example and the one or more embodiments of the present disclosure should not be considered as limited to the bit values, arrangement and/or total token bit length shown. The token length as shown in Table 1 is 10 bits. By way of example, a start of frame token is defined as a bit pattern of 100x01x1x1 as shown in Table 1. Wherein an ‘x’ indicates a “don't care” bit position. As discussed above and by way of example with respect to Table 1, there are three bit positions (D0-D2) defined for the unique peripheral device identification of eight peripheral devices all coupled to a common communications bus, noted as Peripheral 1-Peripheral 8 in the Table. According to one or more embodiments of the present disclosure, all eight peripheral devices might decode and identify the bit pattern 100x01x1x1 as a start of frame token. Further, each peripheral device would also decode bit positions D0-D2 to determine if the data frame is intended for that peripheral device. For example, a start of frame token according to Table 1 of 1000011101 would be identified by Peripheral 3 as intended for that peripheral, whereas peripherals 1-2 and 4-8 would ignore any data presented on the bus following the start of frame token. For example, Peripherals 1-2 and 4-8 might return to a sleep mode according to one or more embodiments of the present disclosure immediately following the start of frame token. These “unselected” peripheral devices may also wait for a end of frame presented on the bus before watching for a new start of frame token to be presented on the bus. Having been identified in the start of frame token as the indicated target of the data frame, Peripheral 3 would then buffer the frame payload presented on the bus following the start of frame token until an appropriate end of frame token was detected by Peripheral 3. Peripheral 3 could then proceed with the appropriate response to receiving the intended data frame over the communications bus.

TABLE 1

| Token | | | | | | | | | | |
|---|---|---|---|---|---|---|---|---|---|---|
| Format | K0 | K1 | K2 | D0 | K3 | K4 | D1 | K5 | D2 | K6 |
| Start of | 1 | 0 | 0 | x | 0 | 1 | x | 1 | x | 1 |
| Frame | | | | | | | | | | |
| Token | | | | | | | | | | |
| Peripheral 1 | | | | 0 | | | 0 | | 0 | |
| Peripheral 2 | | | | 0 | | | 0 | | 1 | |
| Peripheral 3 | | | | 0 | | | 1 | | 0 | |
| Peripheral 4 | | | | 0 | | | 1 | | 1 | |
| Peripheral 5 | | | | 1 | | | 0 | | 0 | |
| Peripheral 6 | | | | 1 | | | 0 | | 1 | |
| Peripheral 7 | | | | 1 | | | 1 | | 0 | |
| Peripheral 8 | | | | 1 | | | 1 | | 1 | |

x = “Don't care.”

As discussed above, it should be noted that various embodiments of the present disclosure are not limited to an 8b/10b encoding scheme for example. Tokens having different bit lengths and more or less than eight peripheral devices might be uniquely identified according to one or embodiments of the present disclosure. For example, embodiments of the present disclosure are not limited to 10 bit tokens. Three additional 10 bit tokens could be packed onto the 10 bit token described above to yield a 40 bit token, for example. This could also provide for additional unique peripheral device identification. It should be noted that control codes (e.g., tokens) such as those discussed above and according to various embodiments of the present disclosure are also not limited to be multiples of 10 bits.

Both peripheral devices and host devices such as those described with respect to FIGS. 1 and 2 might be configured to utilize the unique peripheral device addressing scheme as described above. For example, in a system utilizing a unidirectional communications bus, a host might be configured to perform the encoding function and peripheral devices coupled to the bus might be configured to decode the control codes presented on the bus. In a system utilizing a bi-directional communications bus, both the host and peripheral devices coupled to the bus might be configured to perform both an encoding function and a decoding function dependent upon if the device is operating in a transmit or a receive mode at any given time. Still further embodiments of the present disclosure provide for a combination of the above mentioned systems such that some peripheral devices coupled to the communications bus might be adapted to operate in a bi-directional mode, such as the host and possibly one or more peripheral devices coupled to the bus. One or more different peripheral devices coupled to the bus may only be configured to operated in a unidirectional mode (e.g., receive only), for example.

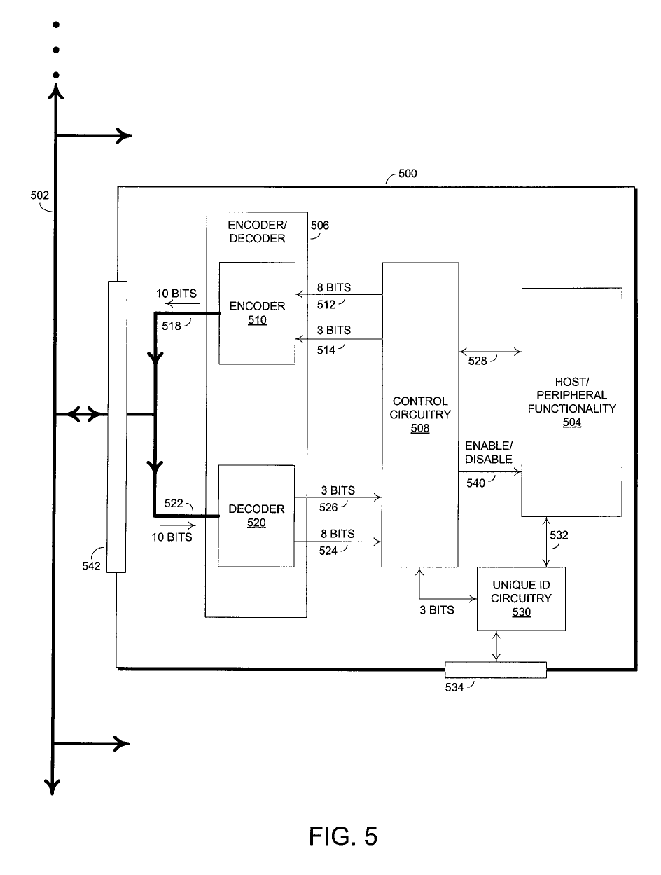

FIG. 5 illustrates an electronic device that is shown having both encoding and decoding functionality according to various embodiments of the present disclosure. The electronic device 500 may comprise a host, such as 102 or might comprise a peripheral device of some type such as 104, for example. The electronic device 500 is further shown coupled to a communications bus 502 which may be of a type discussed above, such as a unidirectional or a bidirectional bus, for example. Additional peripheral devices (not shown) might also be coupled to communications bus 502 that are capable of communication over the bus and that may or may not be configured to function according to various embodiments of the present disclosure. For example, device 500 may be a host device 102 coupled to a system 100/200 along with one or more peripheral devices 104 coupled to the communications bus 502 according to various embodiments of the present disclosure.

According to various embodiments of the present disclosure, a device such as 500 might comprise encoding/decoding circuitry 506 in order to perform the various methods of one or more embodiments of the present disclosure. Device 500 is further shown coupled to a communications bus 502 through an interface 542. Interface 542 is shown to be representative of both the possible mechanical (e.g., electrical connector) interface and/or electrical (e.g., interface signal lines) characteristics of the interface. This interface 542 might be one of the various interfaces conforming to the memory device interfaces as discussed above such as a USB, SD, MMC or other type of interface as are known to those skilled in the art. Device 500 might also be a hard wired or a removable FLASH memory storage device, for example. The device 500 illustrated in FIG. 5 is also shown as comprising Host/Peripheral Functionality circuitry 504. As discussed above, the device 500 might be a host controller or one of a number of types of peripheral devices discussed. Thus, the Host/Peripheral Functionality circuitry 504 is representative of the type of device that device 500 comprises. For example, in the case of device 500 comprising a host, the circuitry 504 might comprise a microprocessor and additional support circuitry to facilitate the operation of the microprocessor. In an example of a peripheral device, circuitry 504 may comprise memory circuitry such as a FLASH memory device. The circuitry 504 could also be an electronic sensor circuit, display circuitry, a user input device and/or a number of other peripheral devices. Device 500 control circuitry 508 is also provided in order to facilitate, at least in part, the various methods and operations performed according to one or more embodiments of the present disclosure. For example, control circuitry 508 can serve as an intermediary between the encoder/decoder 506 functionality of the device 500 with the Host/Peripheral Functionality 504 portion of the device 500.

Device 500 is also illustrated as comprising circuitry 530 which provides unique peripheral identification. For example, the unique ID circuitry might be configured to couple with a connector or interface 534 to allow for various methods of assigning a unique ID to the device 500. For example, device 500 might be installed in a system wherein the unique ID of peripheral devices is assigned based on an installation location in the system. The system might contain a number of interfaces (e.g., sockets) to install a number of peripheral devices, for example. Each socket might be hardwired with three contacts corresponding to eight possible unique IDs (not shown.) For example, the three contacts may be wired as a combination of grounded pins to indicate a unique identification scheme. For example, the three contacts might be representative of bit positions D0-D2 of Table 1 shown above. Contacts at each socket that are not grounded might be left floating or might be pulled up to a supply voltage, for example. Thus, the unique ID circuitry 530 might be configured to sense these three hardwired locations (e.g., pins) as either grounded or pulled high in order to decode the unique ID for a peripheral installed in a particular location (e.g., socket.) Although shown as separate interfaces, interface 542 and interface 534 may also be combined into a common socket, for example. The unique ID circuitry 530 might also comprise a means for a user to manually select the unique device ID. For example, to set eight possible unique peripheral IDs, three switches, referred to sometimes in the art as “dip switches,” might be used wherein the position of each dip switch can be indicative of the three possible bit values to create eight possible unique IDs. The unique ID circuitry may also be configured through other non-electromechanical means. For example, the Host/Peripheral Functionality circuitry 504 might direct the unique ID adopted by the device 500. In another embodiment, the unique ID assignment for the peripheral device might be received over the communications bus 502, such as from a host device (not shown) coupled to the bus 502.

According to one or more embodiments, device 500 might comprise an 8b/10b encoder/decoder as are known to those skilled in the art along with additional circuitry configured to facilitate encoding and/or decoding of data according to various embodiments of the present disclosure. However, it should be noted that various embodiments of the present disclosure are not limited to devices utilizing 8b/10b encoding schemes. A typical 8b/10b encoder comprises an 8-bit register that is first written to and the decoder then translates the 8-bits to the appropriate 10 bits wherein the 10 bits are then presented on the communications bus. A typical 8b/10b decoder receives 10 bits from the communications bus and then decodes the original 8 bits of data which had been previously encoded and transmitted on the bus by a different device (e.g., a host or another peripheral device) coupled to the bus. The device 500 shown in FIG. 5 according to one or more embodiments of the present disclosure, comprises a modified 8b/10b encoder 510 and decoder 520 which exhibit the functionality of a typical 8b/10b encoder and decoder but are further configured to perform the encoding and decoding operations according to the one or more embodiments of the present disclosure.

According to one or more embodiments, the encoder 510 of device 500 is configured to operate in at least two modes. The encoder 510 can operate in a mode wherein eight bits of data are input 512 to the encoder from the control circuitry 508. The encoder 510 then translates the 8 bits 512 to the appropriate 10 bits and presents 518 the 10 bits of data to the coupled communications bus 502 as is done in a typical 8b/10b encoder. For example, as discussed above a certain number of possible 10 bit values correspond to data to be transmitted on the bus as opposed to the potential 10 bit control codes that might be utilized.

A second operating mode of the encoder 510 facilitates a translation operation according to the various embodiments of the present disclosure. For example, a start of frame token such as discussed with respect to FIG. 4 and Table 1 above might need to be generated. This is accomplished by the device control circuitry 508 providing not only a particular eight bits to be translated by the encoder 512 to generate the start of frame bit pattern (e.g., K0-K6), but also an additional three bits are provided 514 to the encoder representative of the unique device identification value that is to be encoded with the start of frame token that will ultimately be placed on the communications bus 502 by the encoder 510. Thus, the encoder 510 according to one or more embodiments translates the 8 bits 512 to generate the appropriate start of frame token bit pattern, such as 100x01x1x1 as discussed above and shown in Table 1. The encoder 510 further encodes the three bit 514 unique identification ID into the appropriate bit locations of the start of frame token, such as in locations D0-D2 as shown in FIG. 4 and Table 1. For example, in order to generate a start of frame token according to one or more embodiments, an eight bit pattern might be used that after translation will allow for the encoder 510 to perform a logical OR operation on the generated start of frame bit pattern (e.g., K0-K6) with the unique three bit 514 device ID information provided by the control circuitry 508. Following this operation, the encoder 510 presents 518 the start of frame token encoded with the unique destination device identifier according to the various embodiments on the communications bus 502 for transmission to other devices (not shown) coupled to the bus 502.

The decoder 520 according to one or more embodiments of the present disclosure is configured to receive 10 bits 522 from the communications bus 502 that has been previously encoded. For example, the decoder 520 may receive what is recognized as a start of frame token, again such as 100x01x1x1 discussed above with respect to Table 1. If this pattern is received, the decoder 520 recognizes the 10 bits as conforming to a defined start of frame token. The decoder further checks the three bit values in bit positions designated for the unique device ID (e.g., D0-D2) encoded in the start of frame token. The decoder compares the D0-D2 unique ID to the unique ID assigned to the device 500 such as by the unique ID circuitry 530 discussed above. If the ID matches, the control circuitry 508 will facilitate 528 the transfer of data that follows the start of frame token to the Host/Peripheral Functionality 504 after the decoder 520 has decoded the data from the 10 bit 522 format to the appropriate 8 bits 524 of data. According to at least one embodiment, the control circuitry 508 might also generate and provide an enable/disable signal 540 to the Host/Peripheral Functionality 504, such as to wake up the device from a low power (e.g., sleep) mode, for example. The enable/disable signal 540 can also be utilized to disable the device 500, such as if the device 500 determines that a received start of frame token does not identify the device 500. This transfer of decoded data 524 from the decoder 520 continues until an end of frame token, such as 306, has been detected. If however, the decoder 520 and/or control circuitry 508 determines that the unique ID encoded in the identified start of frame token does not match the unique ID assigned to the device 500, then the device ignores the data provided on the bus which follows the start of frame token.

Although the device 500 shown with respect to FIG. 5 illustrates a device having both an encoder 510 and a decoder 520 according to one or more embodiments of the present disclosure, the various embodiments are not so limited. A device 500 according to one or more embodiments might only be configured to receive or to transmit encoded data, for example. Thus, various embodiments of the present disclosure might comprise only an encoder 510 or alternatively only a decoder 520, for example.

### CONCLUSION

Electronic devices and methods have been described to facilitate more efficient peripheral device identification during communication with other devices coupled to a communications bus, such as with a host or other peripheral, for example. By utilizing a unique bit pattern along with device identifying information encoded within the unique bit pattern indicative of the intended destination of an associated data packet, a more efficient distribution of data to and from devices coupled to the communications bus can be realized. Bus communication throughput and more efficient utilization of power in a system utilizing the embodiments of the present disclosure can also be realized.

Although specific embodiments have been illustrated and described herein, it will be appreciated by those of ordinary skill in the art that any arrangement that is calculated to achieve the same purpose may be substituted for the specific embodiments shown. Many adaptations of the disclosure will be apparent to those of ordinary skill in the art. Accordingly, this application is intended to cover any adaptations or variations of the disclosure.

What is claimed is:

1. A method of addressing a data payload transmitted on a communications bus, comprising:
transmitting a command comprising a first command portion and a second command portion prior to a transmission of the data payload;
wherein the first command portion has a fixed pattern; and
wherein the second command portion has a pattern representative of a destination address of the data payload.

2. The method of claim 1, wherein transmitting the command comprising a first command portion further comprises transmitting the command where the first command portion comprises a fixed data pattern representative of a start of frame control code.

3. The method of claim 1, wherein transmitting the command further comprises transmitting the command where the first command portion is not permitted in the data payload.

4. The method of claim 1, wherein transmitting the command further comprises transmitting the command wherein a combination of the first command portion and the second command portion are not present in the data payload.

5. A method of addressing a data payload transmitted on a communications bus, comprising:
combining the data payload with a command comprising a first command portion and a second command portion, wherein the first command portion has a fixed pattern and the second command portion has a pattern representative of a destination address where the command is not present in the data payload; and
transmitting the combined data payload and command on the communications bus.

6. The method of claim 5, wherein combining the data payload with the command further comprises combining the data payload with a command where the command is selected from a plurality of control codes.

7. The method of claim 5, wherein combining the data payload with the command further comprises combining the data payload with a command where the fixed pattern of the first command portion is representative of a control code.

8. The method of claim 5, wherein combining the data payload with the command further comprises combining the data payload with a command where the second command portion is logically OR'd with the first command portion to form the command.

9. A method of targeting a data payload transmitted on a communications bus, comprising:
selecting a first command comprising a first portion and a second portion, wherein the first portion has a fixed pattern and the second portion has a pattern representative of a target destination where the command is not present in the data payload;
appending the data payload to the first command; and
transmitting the first command and appended data payload on the communications bus.

10. The method of claim 9, wherein selecting the first command comprising a first portion and a second portion further comprises selecting the first command wherein the first portion is a fixed bit pattern indicative of a start of frame control code.

11. The method of claim 9, further comprising selecting a second command and appending the second command to the data payload prior to transmitting the first command and the appended data payload.

12. The method of claim 11, wherein selecting the second command further comprises selecting the second command wherein the second command comprises a bit pattern indicative of an end of frame control code and where the second command is not present in the data payload.

13. The method of claim 9, wherein selecting the first command further comprises selecting the first command from a plurality of control codes.

14. The method of claim 13, wherein selecting the first command from a plurality of control codes further comprises selecting the first command from a plurality of control codes wherein the plurality of control codes are 8b/10b encoding control codes.

15. A method of operating a device coupled to a communications bus, comprising:
receiving a first command at a device coupled to the communications bus wherein the first command is indicative of a start of new data presented on the communications bus and where the first command comprises a start of frame indicator portion and a unique target identifier portion neither portion being present in the new data presented on the communications bus;
capturing the new data presented on the communications bus in the coupled device if the unique identifier portion of the first command identifies the coupled device; and
rejecting the new data presented on the communications bus by the coupled device following the first command if the unique identifier portion of the first command does not identify the coupled device.

16. The method of claim 15, wherein receiving the first command at the device coupled to the communications bus further comprises receiving the first command prior to receiving the new data on the communications bus.

17. An electronic device, comprising:
a communications bus interface configured to receive new data presented on a communications bus coupled to the bus interface; and
control circuitry, wherein the control circuitry is configured to receive a first command at the bus interface wherein the first command is indicative of a start of new data presented on the communications bus and where the first command comprises a start of frame indicator portion and a unique target identifier portion where neither portion appears in new data presented on the communications bus, capture new data presented on the communications bus in the electronic device if the unique identifier portion of the first command identifies the coupled device and reject new data presented on the communications bus if the unique identifier portion of the first command does not identify the electronic device.

18. The electronic device of claim 17, wherein the control circuitry is further configured to perform a comparison of the unique identifier portion with a particular identifier previously assigned to the electronic device.

19. The electronic device of claim 17, wherein the control circuitry is further configured to disable the electronic device if the unique identifier portion of the first command does not identify the electronic device.

20. The electronic device of claim 19, wherein the control circuitry is further configured to disable the electronic device by entering a sleep mode of operation.

21. The electronic device of claim 17, further comprising a device identification assignment interface having one or more contacts, wherein a device ID is set in response to electrical signals at the one or more contacts.

22. A memory device, comprising:
an array of memory cells;
a communications bus interface configured to receive new data presented on a communications bus coupled to the bus interface;
control circuitry, wherein the control circuitry is configured to receive a first command at the bus interface wherein the first command is indicative of a start of new data presented on the communications bus and where the first command comprises a start of frame indicator portion and a unique target identifier portion where neither portion appears in new data presented on the communications bus, capture new data presented on the communications bus in the electronic device if the unique identifier portion of the first command identifies the coupled device and reject new data presented on the communications bus if the unique identifier portion of the first command does not identify the electronic device.

23. The memory device of claim 22, wherein the array of memory cells comprises an array of non-volatile memory cells.

24. The memory device of claim 22, wherein the memory device is one of a USB flash memory device, SD memory device and MMC memory device.

25. An electronic system, comprising:
a communications bus configured to accept one or more bus devices to be coupled to the communications bus;
a host device coupled to the communications bus, wherein the host comprises:
a processor configured to process data; and
control circuitry, wherein the control circuitry is configured to generate a command, append a processed data payload to the command and transmit the command and appended data payload on the communications bus, wherein the command comprises a first portion and a second portion where the command is not present in the data payload and where the second portion comprises a unique peripheral device identifier; and
wherein the electronic system further comprises a peripheral device coupled to the communications bus, wherein the peripheral device is configured to receive the command, capture the data payload if the unique peripheral device identifier identifies the peripheral device and reject the data payload if the unique peripheral device identifier does not identify the coupled device.
